(19) United States
(12) Patent Application Publication
(10) Pub. No.: US 2004/0123100 A1
(43) Pub. Date: Jun. 24, 2004

(54) Certificate issuing method and certificate verifying method

(76) Inventors: Hideo Noyama, Yokohama (JP); Takeshi Matsuki, Musashino (JP); Hirofumi Inomata, Tokyo (JP); Kenji Yokoi, Fujimi (JP); Mitsuru Iwamura, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/445,989

(22) Filed: May 28, 2003

(30) Foreign Application Priority Data
Dec. 19, 2002 (JP) 2002-367452

(51) Int. Cl. H04L 9/00

(52) U.S. Cl. 713/159

(57) ABSTRACT

A certificate issuing method includes inputting individual information of a certificate issuance requester, creating electronic data of a board having a background pattern that differs from certificate to certificate on a part thereof, overwriting individual information on the background pattern in the electronic data of the board with characters, entering a relation between the background pattern and the overwritten characters onto the board, and printing the electronic data as a certificate. A certificate verifying method includes converting the certificate to electronic data, reading a relation between a background pattern and overwritten characters on the certificate, extracting a region in which individual information is overwritten on the background pattern with characters, from the certificate, effecting a check to determine whether the background pattern and the characters in the region satisfy the relation, and judging the certificate invalid when the background pattern and the characters do not satisfy the relation.

### CROSS-REFERENCE TO RELATED APPLICATION

This application relates to U.S. patent application Ser. No. 10/378,113 filed on Feb. 28, 2003 assigned to the present assignee. The content of the application is incorporated herein by reference.

### BACKGROUND OF THE INVENTION

1. Field of the Invention

The present invention relates to a technique for creating a certificate and a technique for verifying the certificate. In particular, the present invention relates to a certificate issuing method that makes it possible to print certificate data granted on line by using a user's printer, and a certificate verifying method that makes it possible for a verifier to verify genuineness or spuriousness of a printed matter without inquiring of the certificate issuer.

2. Description of the Related Art

As for conventional techniques concerning electronic certificate, the following can be mentioned. As described in, for example, JP-A-2001-134672, there is a technique of ascertaining the genuineness or spuriousness of a printed matter and ascertaining the validity in an offline environment. As described in JP-A-2001-357154, there is a technique of using a printed matter printed by an applicant who requests certification, as an official certificate. As described in JP-A-2002-279099, there is also a technique of retrieving certificate data on the basis of a data base for managing information whereby persons can be identified and certificate data in association and on the basis of key information.

### SUMMARY OF THE INVENTION

A first object of the present invention is to provide a system, and method, capable of issuing a certificate online by using a printer, without using special paper or a special printing device, so long as the printer performs some function.

A second object of the present invention is to provide a system, and method, whereby a verifier can easily verify validity of a certificate.

In order to achieve these objects, a method for issuing a certificate includes the steps of inputting individual information of a certificate issuance requester, creating electronic data of a board, the board having a background pattern that differs from certificate to certificate on a part thereof, overwriting individual information on the background pattern in the electronic data of the board by using characters, entering a relation between the background pattern and the overwritten characters onto the board, and printing the electronic data as a certificate. A method for verifying a certificate includes the steps of converting the certificate to electronic data, reading out a relation between a background pattern and overwritten characters on the certificate, extracting a region in which individual information is overwritten on the background pattern with characters, from the certificate, effecting a check to determine whether the background pattern and the characters in the region satisfy the relation read out, and judging the certificate to be invalid when the background pattern and the characters in the region do not satisfy the relation read out.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example of a certificate issued on line according to the present invention;

FIG. 2 is a system configuration diagram showing a connection relation example of a system according to the present invention;

FIG. 3 is a diagram showing information given to a certificate shown in FIG. 1 to verify the genuineness or spuriousness of a printed certificate;

FIG. 4 is a diagram showing processing conducted on a region 120 and a region 130 shown in FIG. 1;

FIG. 5 is a diagram showing a method for painting out regions shown in FIG. 4;

FIG. 6 is a basic processing flow chart concerning processing for issuing a certificate on line;

FIG. 7 is a basic processing flow chart showing processing for verifying the genuineness or spuriousness of a printed certificate;

FIG. 8 is a diagram showing an example of a dot pattern different from that shown in FIG. 4;

FIG. 9 is a system configuration diagram of a board issuing system;

FIG. 10 is a system configuration diagram of a certificate issuing system;

FIG. 11 is a system configuration diagram of a verifier system;

FIG. 12 is a system configuration diagram of a requester system;

FIG. 13 is a flow chart showing a method for generating a painting out pattern in a region in which individual data are stated according to a second embodiment;

FIG. 14 is a flow chart showing step 1350 in FIG. 13 in detail;

FIG. 15A is a diagram showing an example of a pattern created by processing shown in FIG. 13;

FIG. 15B is a diagram showing an example in which a character is overwritten on a pattern shown in FIG. 15A and code information is embedded therein;

FIG. 16 is a processing flow for overwriting individual data on a pattern of a board according to a second embodiment;

FIG. 17 is a diagram showing an example in which a Voronoi diagram is applied in order to paint out a board according to a third embodiment;

FIG. 18 is an association table showing relations between paying out patterns for 2 by 2 pixels and paying out colors corresponding thereto;

FIG. 19 is a diagram showing an example in which a painting out association table shown in FIG. 18 is applied to the periphery of overwritten characters;

FIG. 20 is a diagram showing a result obtained by further conducting painting out processing on FIG. 19;

FIG. 21 is a diagram obtained by superposing FIG. 20 on FIG. 17 and extracting colors that are in dot positions in order to decide a painting out color in each of regions in the Voronoi diagram;

FIG. 22 is a diagram showing an example of painting out characters written in the region in which individual data of a certificate is stated and painting out the periphery of characters;

FIG. 23 is a diagram showing an example in which a part of a Japanese character “ [symbol] ” is retouched and an association table shown in FIG. 18 is applied to the retouched character;

FIG. 24 is a diagram showing an example in which periphery of a retouched character is painted out; and

FIG. 25 is a diagram showing a different method for representing a local shape by using colors.

### DESCRIPTION OF THE EMBODIMENTS

Hereafter, embodiments of the present invention will be described in detail.

1. First Embodiment

(1) System Configuration

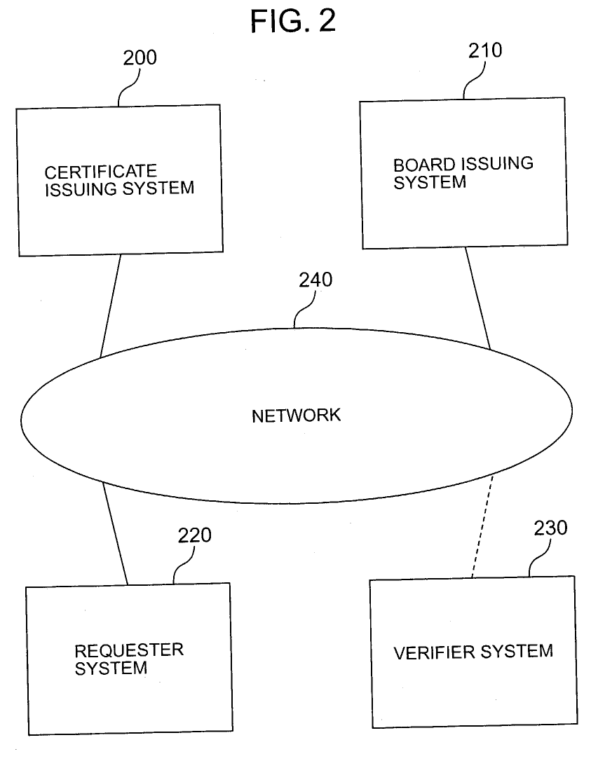

FIG. 2 is a system configuration diagram showing connection relations of a certificate issuing and verifying system. The system include a certificate issuing system 200 for issuing a certificate, a board issuing system 210 for creating a certificate board, a requester system 220 for requesting that a certificate should be issued, and a verifier system 230 for verifying validity of a certificate. Each of the systems shown in FIG. 2 is a computer. A program stored in a storage medium is read into a memory, and processing according to the program is executed.

The certificate issuing system 200, the board issuing system 210, ad the requester system 220 are connected via a network 240. The verifier system 230 need not be always connected to the network 240. However, it is desirable that the network 240 can be connected according to the verification level.

These systems are logical devices The certificate issuing system 200 and the board issuing system 210 may be implemented by using the same computer. The certificate issuing system 200 may include the requester system 220.

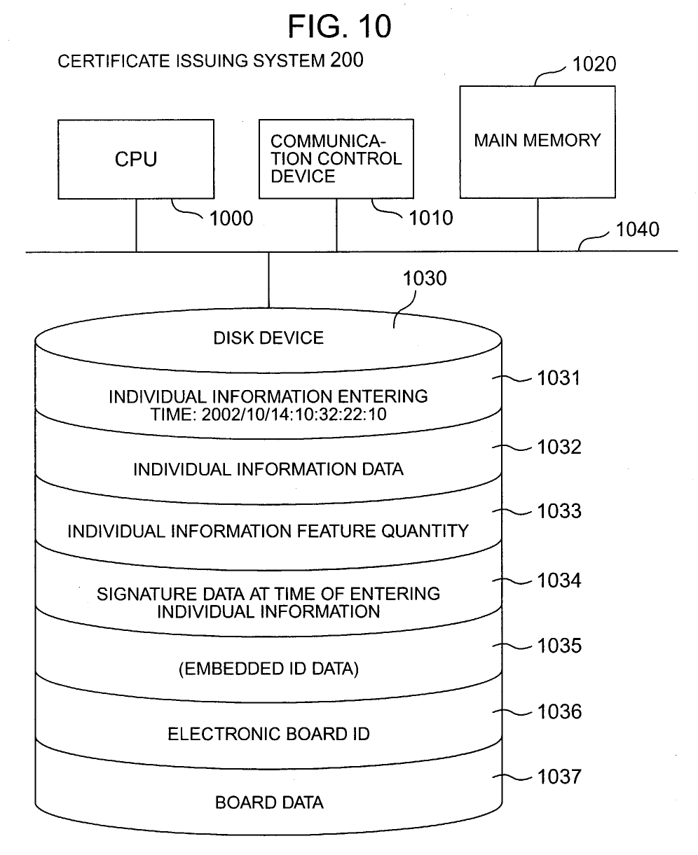

FIG. 10 is a configuration diagram of the certificate issuing system 200. The certificate issuing system 200 includes a CPU 1000, a communication control device 1010, a main memory 1020, a disk device 1030, and a bus 1040. The disk device 1030 stores data 1031 to 1037 for issuing individual certificates in a table form, and stores a certificate issuing program. The certificate issuing program is loaded in the main memory 1020, and executed by the CPU 1000.

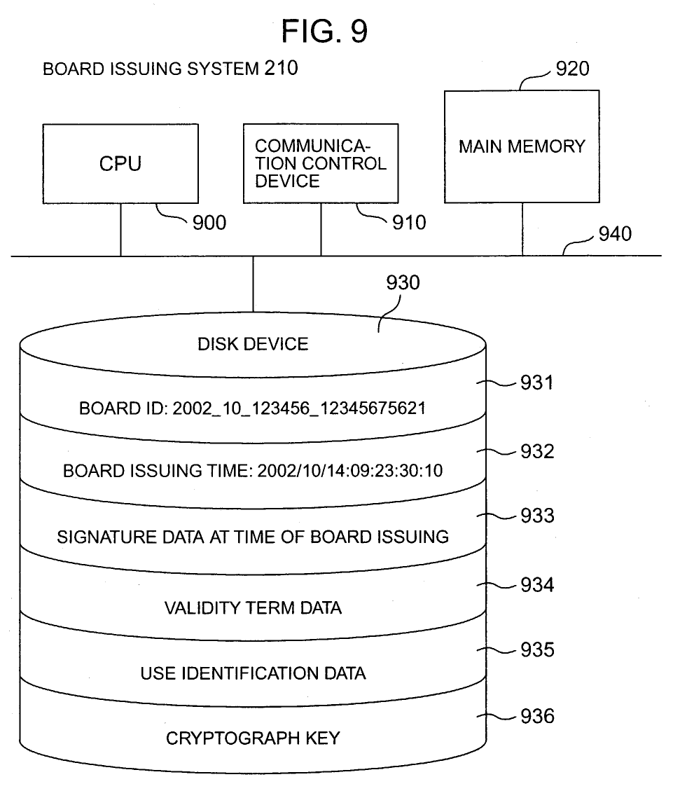

FIG. 9 is a configuration diagram of the board issuing system 210. The board issuing system 210 includes a CPU 900, a communication control device 910, a main memory 920, a disk device 930, and a bus 940. The disk device 930 stores data 931 to 936 for issuing individual boards in a table form, and stores a board issuing program. The board issuing program is loaded in the main memory 920, and executed by the CPU 900.

FIG. 12 is a configuration diagram of the requester system 220. The requester system 220 includes a CPU 1200, a communication control device 1210, a main memory 1220, an input device 1240 such as a keyboard or a scanner, a display device 1250, an output device 1260 such as a printer, and a bus 1230.

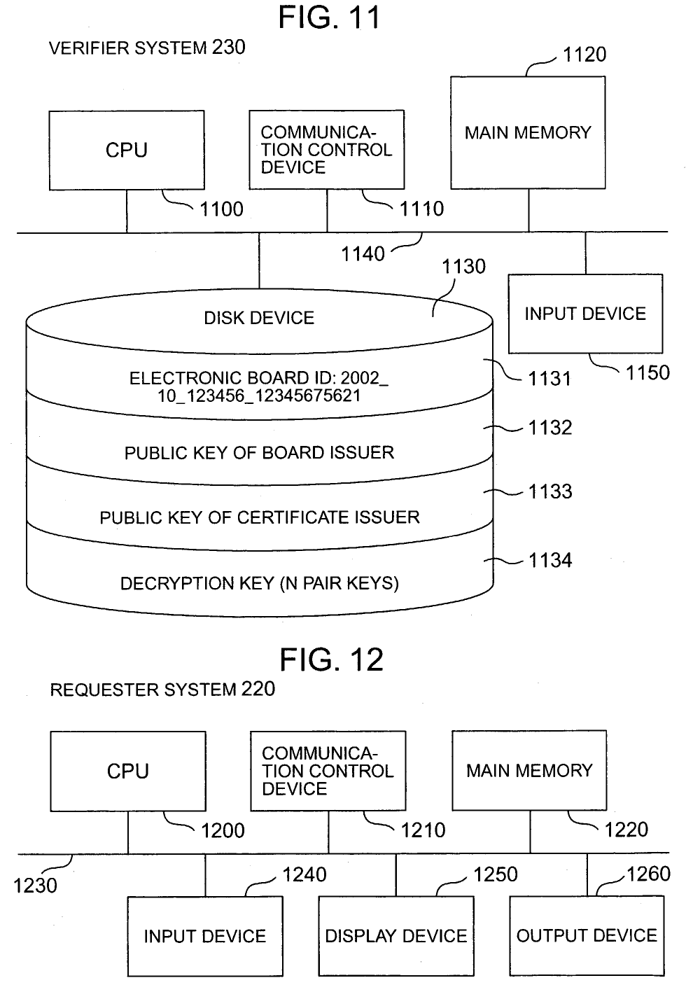

FIG. 11 is a configuration diagram of the verifier system 230. The verifier system 230 includes a CPU 1100, a communication control device 1110, a main memory 1120, a disk device 1130, a bus 1140, and an input device 1150 such as a scanner. The disk device 1030 stores data 1131 to 1134 for verifying a certificate in a table form, and stores a verifying program. The verifying program is loaded in the main memory 1120, and executed by the CPU 1100.

(2) Certificate

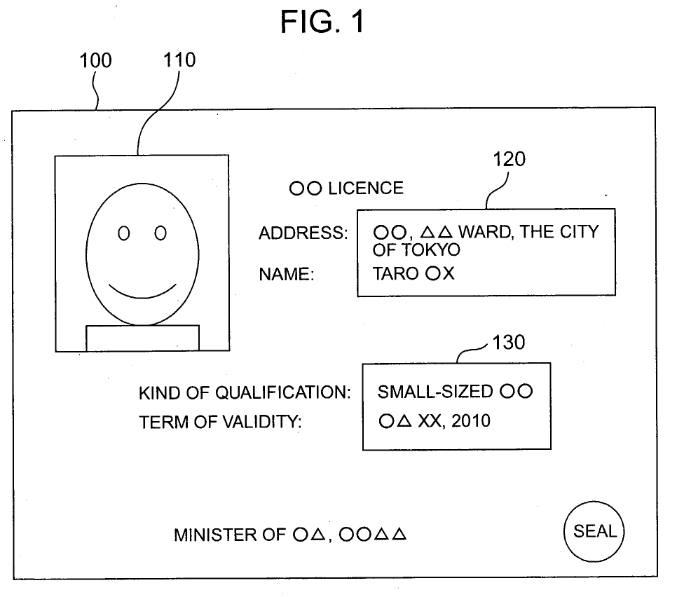

FIG. 1 is a diagram showing an example of a certificate issued online. A certificate 100 is shown to be a driving license as an example in FIG. 1. Typically, the certificate 100 includes a region 110 on which a photograph of face is stuck, a region 120 in which data relating to a person, such as an address, is stated, and a region 130 in which a kind and a validity term of the license are stated. In a remaining portion, a signature and a seal of a representative of an issuing post are stated. As for other examples of the certificate, there are a business license, an identification card, and a passport. According to the certificate, stated data differs.

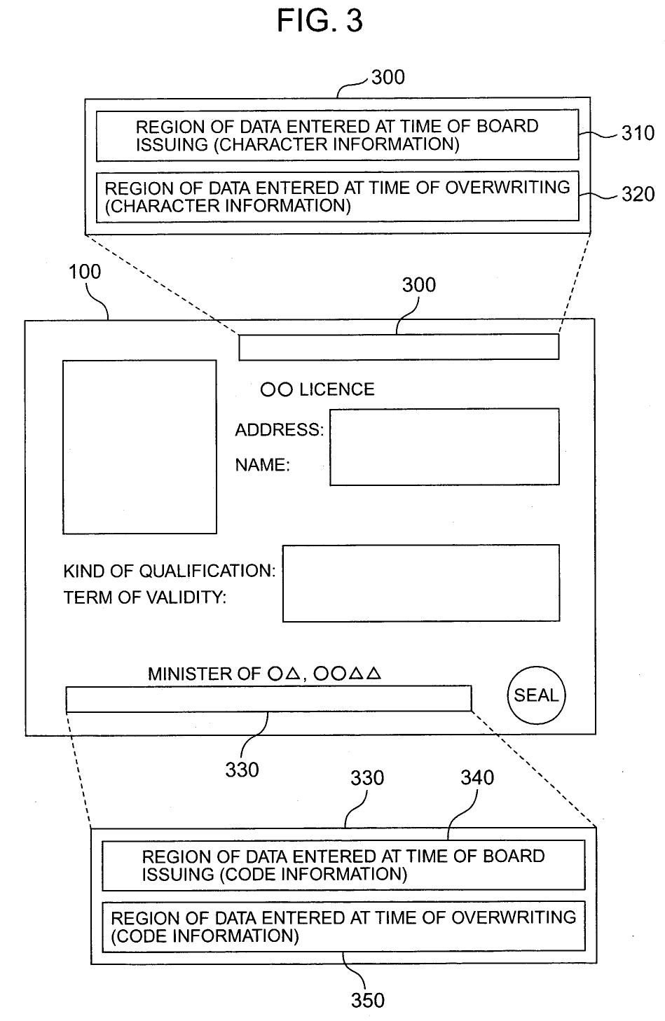

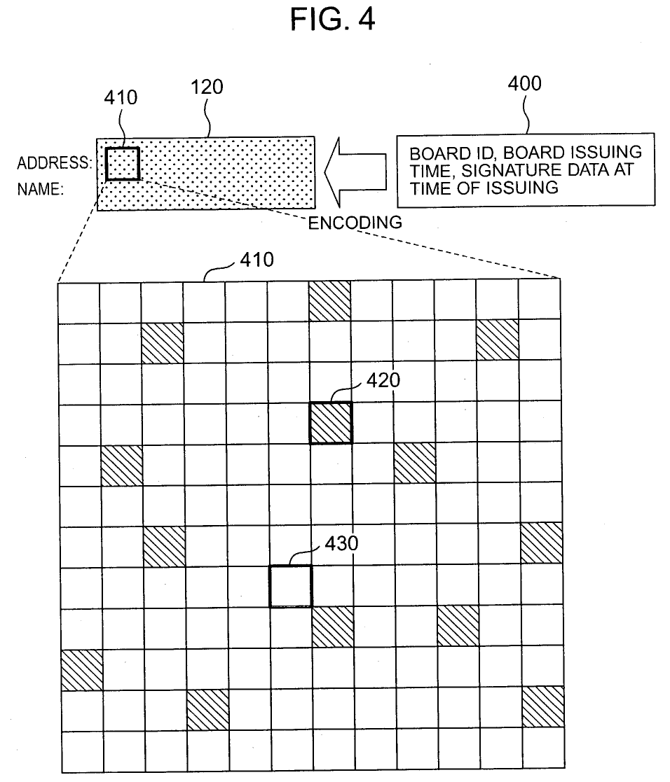

FIGS. 3 and 4 are diagrams showing data added to the certificate shown in FIG. 1 in order to prevent forgery.

FIG. 3 will now be described. In FIG. 3, a region 300 in which character information is stated, and a region 330 in which code information is written are provided in a region other than the data regions shown in FIG. 1. Herein, the character information is information represented by characters such as the alphanumeric characters, ‘kana’s (the Japanese syllabary), and ‘kanji’s (Chinese characters used in Japanese writing). Humans can directly read the character information, whereas code information refers to information, such as bar code and two-dimensional codes, that can be read by using an information processing device.

In the two-dimensional codes, there are codes of stack type formed by stacking bar codes, and codes of matrix type formed by arranging black and white cells having the same size in the length and breadth directions. Two-dimensional bar codes other than them, and codes for recording information in the same way as them may also be used.

Each of the character information stating region 300 and the code information writing region 330 is divided into two regions. Data, such as a board ID, board issuing time, and a signature at the time of board issuing, are stated in the regions 310 and 340, respectively by using characters and codes. Data, such as a signature at the time of individual information writing and data for verifying, are stated in the regions 320 and 350, respectively by using characters and codes.

FIG. 4 is a diagram showing processing conducted on the region 120 and the region 130 shown in FIG. 1 by the board issuing system 210. FIG. 4 shows an image obtained when the board issuing system 210 encodes data 400, such as the board ID, the board issuing time, and the signature data at the time of board issuing, and writes the encoded data into the region 120. By using this image as a background, character information is overwritten.

If a partial region 410 in the region 120 is enlarged, then we find pixels 420 each represented as a black dot and pixels 430 each represented as a blank. For example, assuming that a character is represented by eight bits, the data represented in hexadecimal notation becomes two hexadecimal digits. One hexadecimal digit is represented by a square of four dots by four dots, and a value in the range of 0 to 15 is represented by a position of one black dot in the square. Therefore, two squares (32 dots) can represent one character. Data 400 includes a plurality of character strings. If encoding is conducted by using the above-described method, therefore, the region 120 is filled with the pattern indicated by 410. Here, an example of simply encoding the data 400 has been described. In order to prevent forgery of data, however, the data 400 may be encrypted and then encoded. In order to fill up the entire region with patterns, the data may be stated repetitively. By the way, the size of the overwritten characters is 120 dots by 120 dots per character. However, characters having a different size may be used.

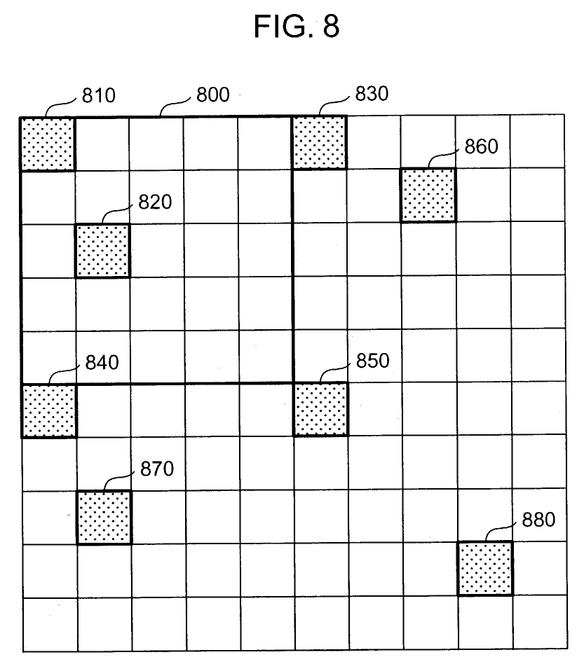

FIG. 8 is a diagram showing another example of the background pattern in the regions 120 and 130. In FIG. 8, the region to be painted is divided into 5 dot by 5 dot squares 800, and upper left-hand pixels (810, 830, 840, and 850) of the squares are always painted out as division reference points of hexadecimal codes. And lower right-hand 16 dots correspond to the above-described 4 by 4 square. By doing so, the information of the character strings are distributed randomly as indicated by pixels 820, 860, 870 and 880. Since the pixels 810, 830, 840, and 850 serving as reference points are arranged regularly, however, data detection is facilitated.

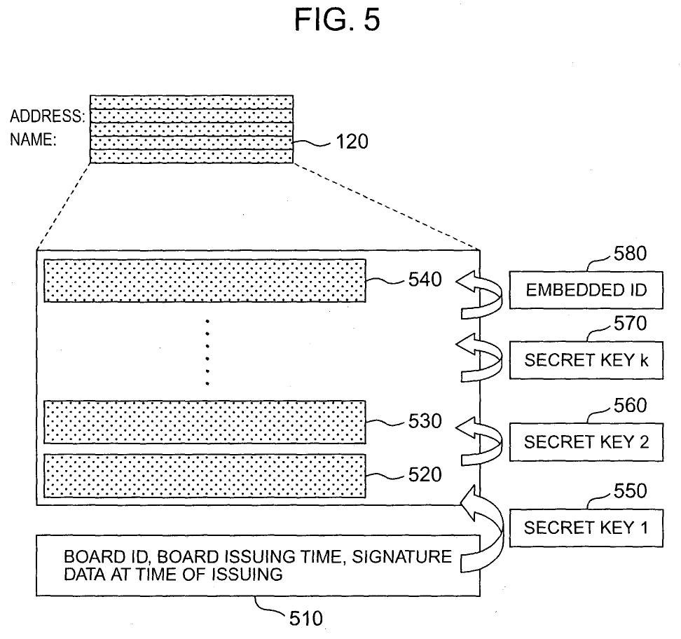

FIG. 5 is a diagram of an example showing a method of filling a region with encoded patterns. In the case where contents of data 510 are encoded and the region 120 is repetitively filled, the same pattern is used repetitively many times. For example, if it is found that the pattern 520 is the same as the pattern 530, it becomes possible to erase overwritten characters by using the pattern 530 even if a part of the pattern 520 is erased by the overwritten characters. As a method for preventing this, the board issuing system 210 prepares secret keys of several kinds in order to encrypt the contents 510, creates cryptograph data 1 encrypted with a secret key 1 (550), and draws a pattern obtained by encoding the cryptograph data 1, in the region 520. In addition, the board issuing system 210 creates cryptograph data 2 encrypted with a secret key 2 (560), and draws a pattern obtained by encoding the cryptograph data 2, in the region 530. By repeating such processing, the board issuing system 210 paints out the region 120. By doing so, the patterns with which the region 520 has been filled differ from the patterns with which the region 530 has been filled. Therefore, the illegality as described above cannot be performed. In FIG. 5, an embedded ID 580 is used for the processing instead of a secret key k+1, and the embedded ID 580 is a kind of a random number.

One secret key may be used, or two secret keys may be used alternately. The embedded ID may not be used.

(3) Certificate Issuing

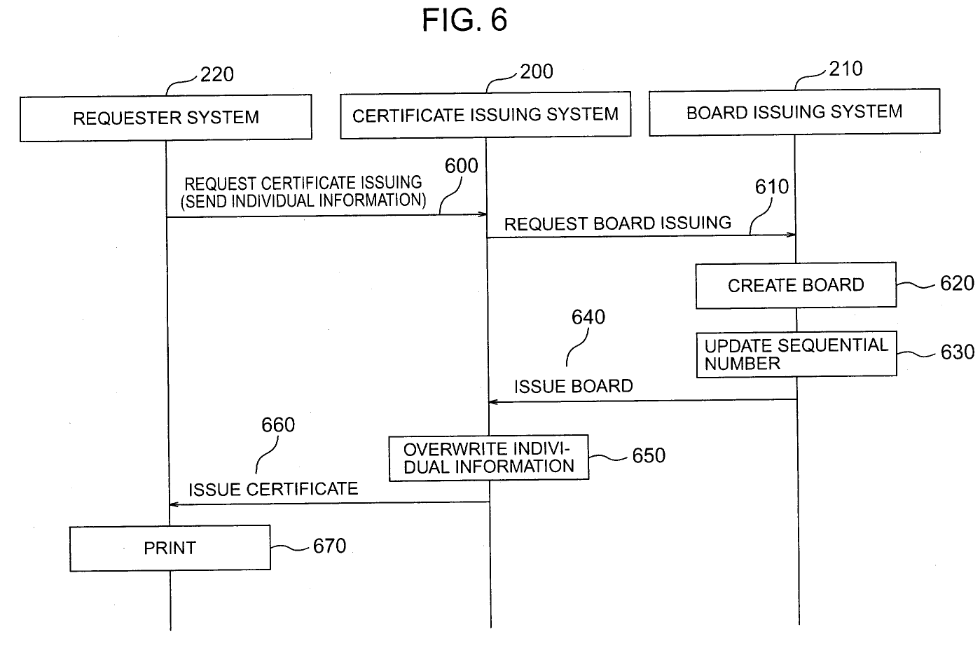

FIG. 6 is a basic processing flow chart showing a process for issuing a certificate online.

The requester system 220 accepts personal information, such as an address, a name and a photograph, from a certificate requester. The requester system 220 may have a device for performing personal authentication. The requester system 220 transmits the accepted individual information including data such as the personal information, the certificate kind and the validity term to the certificate issuing system 200 in the form of electronic data.

The certificate issuing system 200 accepts a certificate issuing request from the requester system 220 at step 600 shown in FIG. 6. And the certificate issuing system 200 specifies a certificate kind and requests the board issuing system 210 to issue a board at step 610.

With respect to the request at the step 610, the board issuing system 210 generates a board ID unique in the system every time it issues a board. For example, the board ID is a concatenation of a code indicating the certificate kind and a sequential number under the certificate kind. In addition, the board ID may include a random number.

The board issuing system 210 creates a board at step 620. In other words, the board issuing system 210 electronically creates the board data shown in FIG. 1. In addition, the board issuing system 210 enters a board ID, board issuing time, and signature data at the time of board issuing in the regions 310 and 340, respectively by using characters and codes. The signature data at the time of board issuing is typically data obtained by encrypting a hash value of concatenated data composed of the board ID and the board issuing time with a secret key of the board issuing system 210. In addition, the board issuing system 210 enters background patterns of the region 120 and the region 130 according to the above-described method.

The board issuing system 210 stores information at the time of board issuing in the disk device shown in FIG. 9 every board ID. A board ID 931, board issuing time 932, and signature data 933 at the time of board issuing are stored in the disk device 930. Attribute information attached to the board is also stored as validity term data 934 and use identification data 935. In addition, a cryptograph key used for background data creation described with reference to FIG. 4 or FIG. 5 may also be stored in a region 936.

Subsequently, the board issuing system 210 updates the sequential number at step 630 (FIG. 6).

The board issuing system 210 transmits the issued board data (electronic data) to the certificate issuing system 200 by using the communication control device 910 at step 640.

At step 650, the certificate issuing system 200 receives board data via the communication control device 1010 and enters individual information into the board data. In other words, the certificate issuing system 200 attaches a picture image to the region 110, and overwrites the individual information (such as the address, name and the validity term) on the region 120 and the region 130 by using characters. In the picture image 110, information such as the board ID is inserted by using the digital watermark technique. The certificate issuing system 200 records the total number of black dots (before character overwriting) on the region 120 and the region 130, the total number of black dots painted out by characters when overwriting characters on the regions, and their coordinates, as data for verification.

In addition, the certificate issuing system 200 enters signature data of the individual information and the data for verification into the region 320 and the region 350 shown in FIG. 3, respectively by using characters and codes. The signature data of the individual information is typically data obtained by encrypting a hash value of the individual information with a secret key of the certificate issuing system 200. It is desirable that the data for verification is entered by using only the codes.

The certificate issuing system 200 stores information obtained at the time of issuing a certificate in the disk device 1030 shown in FIG. 10 for every certificate. Certificate issuing time 1031, individual information 1032, a hash value 1033 of the individual information, and signature data 1034 of the individual information are stored in the disk device 1030. Regions for managing board information are also included on the disk device 1030. A board ID 1036, and board data 1037 sent from the board issuing system are previously recorded on the disk device 1030. In addition, the certificate issuing system 200 may receive the embedded ID used at the time of creating a background pattern as shown in FIG. 5 from the board issuing system, and store the embedded ID in a region 1035.

At step 660 (FIG. 6), the requester system 220 can obtain certificate data (electronic data) by using the communication control device 1210, and display the certificate data on the display device 1250. At step 670, the requester system 220 sends certificate data to the output device 1260, and prints the certificate data on paper.

(4) Certificate Verifying

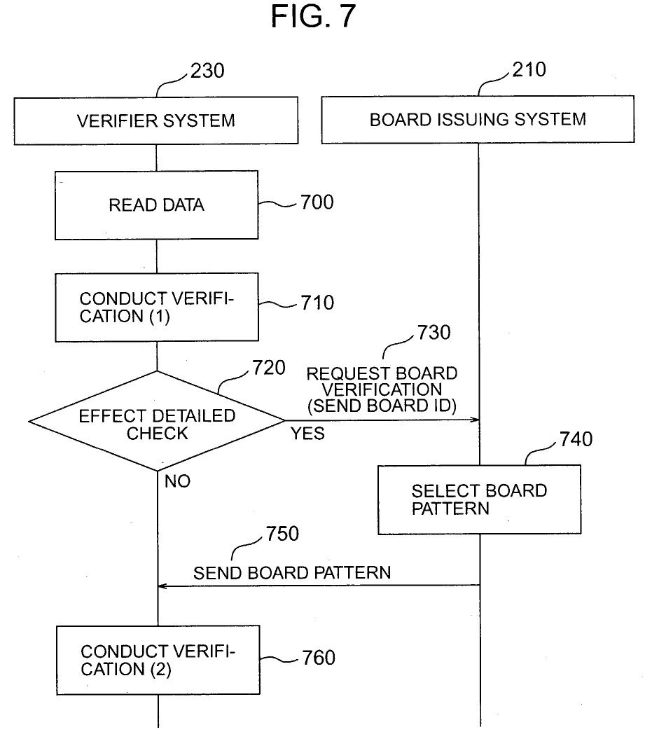

FIG. 7 shows a process for verifying the genuineness or spuriousness of a certificate. At step 700, the verifier system 230 reads a certificate, which is a printed matter, by using the scanner 1150. At step 710, local verification (verification (1)) is performed in the verifier system.

As methods frequently used when forging a certificate, there are a method of (a) erasing a currently written character (individual information) and writing a different character, and a method of (b) retouching a currently written character to form a different character. The total number of black dots (before character overwriting) on the region 120 and the region 130, the total number of black dots painted out by characters when overwriting characters on the regions, and their coordinates are previously written in the region 350 on the certificate 100 as data for verification by using codes.

At step 700, the verifier system 230 counts the number of black dots in the background pattern in the region 120 and the region 130 on the read certificate, and compares the count with the data for verification on the region 350. If a result of the comparison indicates noncoincidence between them, then the verifier system 230 judges the certificate to be invalid. By this processing, the above-mentioned forgery can be detected at a considerable high probability. In addition, the verifier system 230 can detect forgery at a further high probability by comparing the coordinates of a black dot painted out by characters in the data for verification with character positions in the region 120 and the region 130 of the read certificate.

In the case where verification of a higher level is needed (720), the verifier system 230 is connected to the network 240 to perform some or all of the following verifications (verification (2)).

Case 1: The verifier system 230 extracts board ID from the region 310 of the read certificate, sends the board ID to the board issuing system 210, and requests the board issuing system 210 to verify the board (step 730). The board issuing system 210 reconstructs a background pattern from the stored data, and sends the background pattern to the verifier system 230 (step 730). The verifier system 230 ascertains that the background pattern of the read certificate coincides with the background pattern sent from the board issuing system in a portion other than characters (step 760). As a result, the case where the background pattern is forged can be detected.

Case 2: The verifier system 230 extracts signature data from the region 300 or 330 of the read certificate, obtains a public key of the board issuing system 210 and the certificate issuing system 200, and verifies the signature data. This is a well known digital signature verifying method. The public key may be stored on the disk device 1130 in the verifier system 230. This verification may be conducted together with the verification (1).

Case 3: This can be applied only to the case where the background pattern in each of the regions 120 and 130 is created by using a pattern formed by repetitively using the data of the same set as shown in FIG. 5, and characters are not overwritten on the pattern corresponding to data of one set in a predetermined region. The verifier system 230 extracts the pattern corresponding to data of one set in a predetermined region from the regions 120 and 130 in the read certificate. The background pattern in the regions 120 and 130 can be reconstructed according to a method opposite to the method shown in FIG. 5 by using the embedded ID used in FIG. 5, the public key corresponding to the secret key used in FIG. 5, and the extracted pattern. By comparing the read background pattern with the reconstructed background patter, forgery of the background can be detected. A decryption key used at this time may be stored in the disk device 1130 in the verifier system 230.

2. Second Embodiment

(1) Certificate Issuing

In this embodiment, the board issuing system and the certificate issuing system are implemented as the same one system (referred to as board & certificate issuing system). Furthermore, the creation method of the background pattern in the region 120 and the region 130 of the certificate differs from that of the first embodiment. Besides using a plurality of colors in the background pattern, the background pattern changes according to the individual information. Other portions are the same as those of the first embodiment.

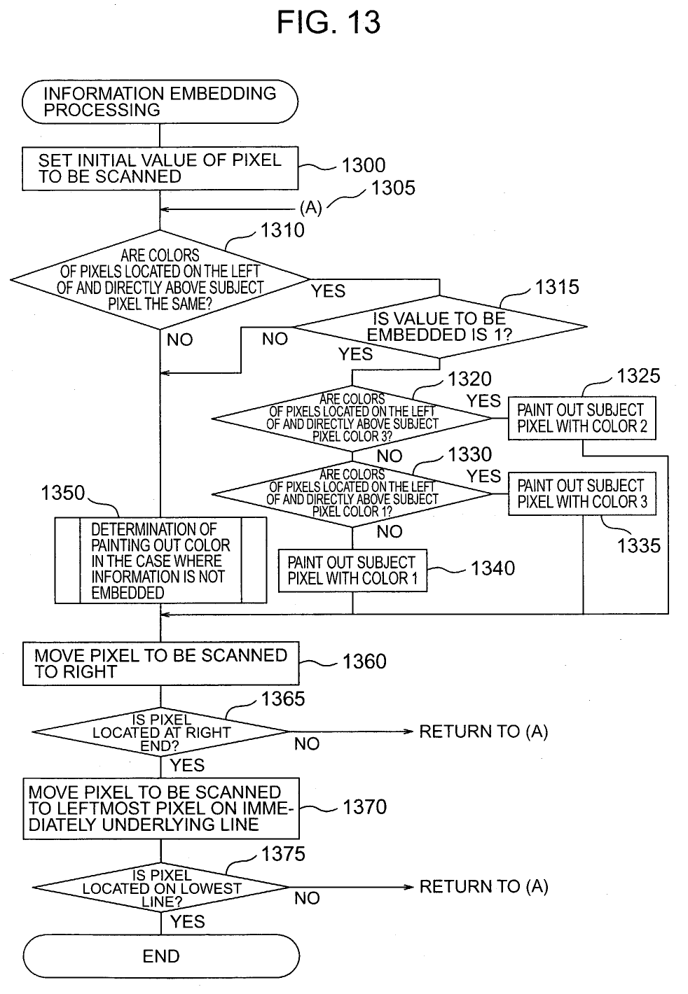

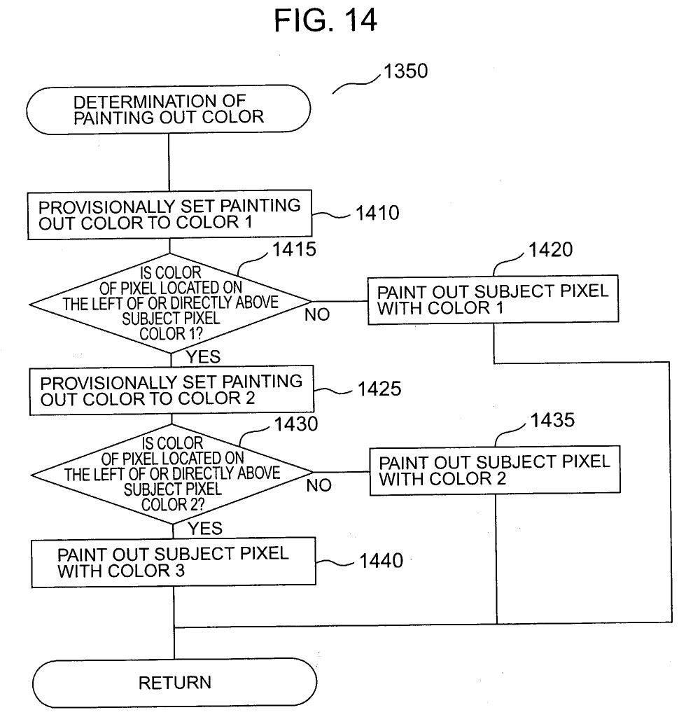

FIGS. 13 and 14 are flow charts concerning the method for generating patterns that paint out the region 120 and the region 130. First, a method for generating a basic pattern will now be described briefly. As the basic pattern, a pattern in which each of pixels included in a region is painted with one of three colors (color 1, color 2 and color 3) is created. At this time, painting is performed so as to provide adjacent pixels in the vertical direction and the horizontal direction with different colors. The simplest way of painting is painting the color 1, color 2 and color 3 in the cited order repetitively, and pixels in the highest line are painted with one color after another in one lateral line. Subsequently, in a second highest line, pixels are painted in the order of the color 2, color 3 and color 1 repetitively, with the leftmost pixel being painted out with the color 2. In a third highest line, pixels are painted in the order of the color 3, color 1 and color 2 repetitively, with the leftmost pixel being painted out with the color 3. By repeating this up to the lowest line, the region 120 and the region 130 can be painted out with the three colors. This is referred to as basic pattern. As for the colors, primary colors used in the printer can also be used. For example, three colors may also be selected from cyan, magenta, yellow and black. The colors are not restricted to three colors, but four colors may also be used.

Subsequently, processing of embedding the board ID and the individual information in the basic pattern is conducted. This processing is shown in FIG. 13.

The board & certificate issuing system conducts initial value setting for scanning the region 120 or the region 130 at step 1300. For example, an upper left-hand pixel is set to an initial value. At step 1310, the pixel color is checked with respect to a pixel located on the left side of a subject pixel and a pixel located directly above the subject pixel. If these two pixels are the same in color, then the processing proceeds to step 1315. If these two pixels are different from each other in color, then the processing proceeds to step 1350.

At the step 1315, the board & certificate issuing system judges whether information is embedded for pixels. For example, the board ID is “11,” and the board ID is embedded in an image. By the way, “11” is represented in the decimal notation, but it is represented as “1011” in the binary notation. For embedding the value “11” in pixels, therefore, at least four pixels are needed, and “1”, “0”, “1”, and “1” are embedded in four pixels, respectively. Referring back to the step 1315, it is determined whether the value to be embedded in the subject pixel is “1” or “0”. If the value to be embedded in the subject pixel is “1”, then the processing proceeds to step 1320. If the value to be embedded in the subject pixel is “0”, then the processing proceeds to step 1350. At the step 1320, the colors of the pixel located on the left side of the subject pixel and the pixel located directly above the subject pixel are checked. If the colors are the color 3, then the subject pixel is painted out with the color 2 at step 1325.

If the colors are not the color 3, but are the color 1, then a decision is made at step 1330, and the subject pixel is painted out with the color 3 at step 1335. If the colors are neither the color 3 nor the color 1, then the colors are inevitably the color 2, and consequently the subject pixel is painted out with the color 1 at step 1340. Processing conducted at the step 1350 is processing that concerns determining a color of a pixel in which information cannot be embedded, and it will be described with reference to FIG. 14.

If the color of the subject pixel is decided, then a pixel to be scanned is moved rightward by one pixel at step 1360. However, if the pixel is located at the rightmost end at step 1365, then the processing proceeds to step 1370. Otherwise, the processing returns to step 1305. In the same way, the pixel to be scanned is moved downward by one line at the step 1370. If the pixel is located on the lowest line at step 1375, then the processing is finished. Otherwise, the processing returns to step 1305 and the processing is continued.

FIG. 14 is a flow showing the step 1350 in detail. At step 1410, the board & certificate issuing system provisionally sets the painting out color of the subject pixel to the color 1. At step 1415, the color is checked with respect to a pixel located on the left side of the subject pixel and a pixel located directly above the subject pixel. If neither of these two pixels has the color 1 (in other words, both of them have the color 2, both of them have the color 3, or one pixel has the color 2 and the other pixel has the color 3), then the subject pixel is painted out with the color 1. If at least one has the color 1 at the step 1415, then the painting out color is provisionally set to the color 2 at step 1425. And at step 1430, the colors are checked in the same way as the foregoing description. If neither of the pixel located on the left side of the subject pixel and the pixel located directly above the subject pixel has the color 2, then the subject pixel is painted out with the color 2 at step 1435. If the color 2 is included at the step 1430, then one of the pixel located on the left side of the subject pixel and the pixel located directly above the subject pixel has the color 1, and the other has the color 2. At step 1440, therefore, the subject pixel is painted out with the color 3. By conducting such processing, individual information can be embedded in the basic pattern while keeping the rule that adjacent pixels are always painted out with different colors.

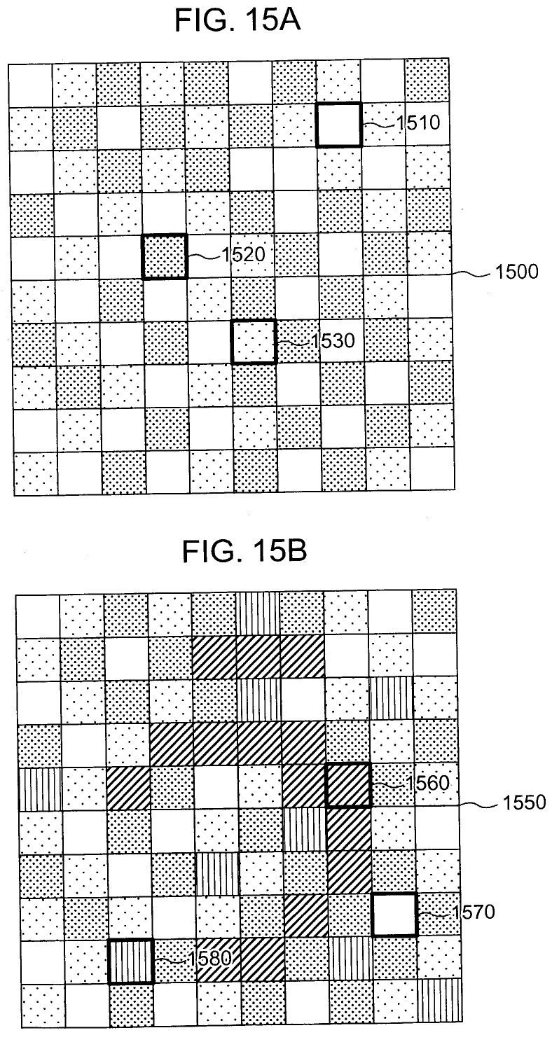

FIG. 15A shows an example of a board pattern thus created. Individual information is overwritten on the board pattern with characters, and in addition, its code or hash value is embedded in the background pattern. FIG. 15B is a diagram showing an example in which a Japanese letter “ [symbol] ” (pronounced as “u”) is overwritten on the board and the code or hash value is embedded in the board.

In FIG. 15A, a pixel 1510 in a region 1500 is painted with the color 1, a pixel 1520 is painted with the color 2, and a pixel 1530 is painted with the color 3. Adjacent pixels are painted out with different colors. In FIG. 15B, the character is superposed on a pixel 1560. In addition, code information of the character “ [symbol] ” is embedded in a pixel 1580 painted with the color 1 in FIG. 15.

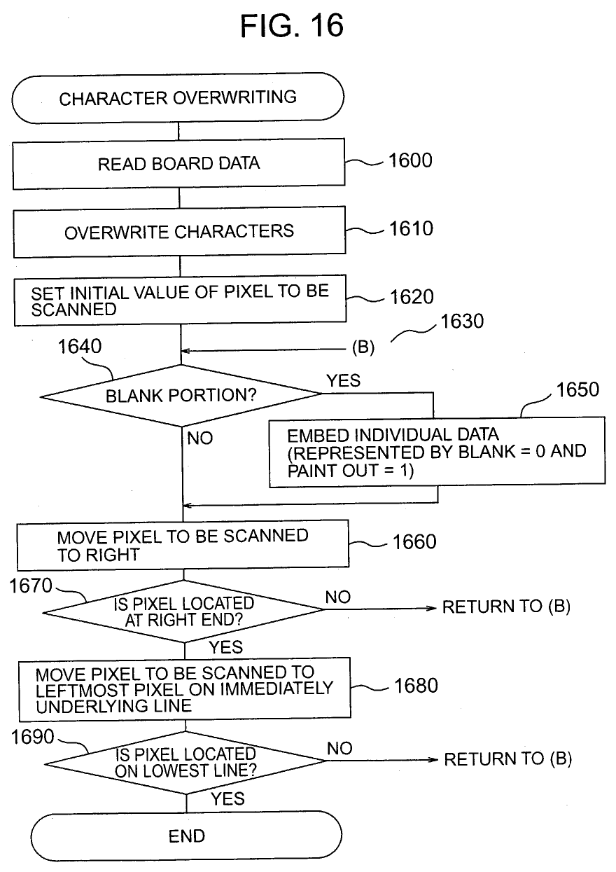

FIG. 16 shows a flow of processing of further embedding code information in the background pattern of the board. At step 1600, board data is read, and a character of individual data is overwritten on the board (step 1610). At this time point, pixels that overlap the character, such as the pixel 1560, are painted out with the color of the character (for example, black).

At step 1620, for example, a top leftmost pixel in a region is set as an initial value. At step 1640, it is determined whether the color of the subject pixel is the color 1 (here the color 1 is represented as blank). If the color of the subject pixel is the color 1, then individual data to be embedded is embedded by using the same method as that described with reference to FIG. 13. In other words, if the value to be embedded is 0, then the painting out color is unchanged at step 1650. If the value to be embedded is 1, then the painting out color is set to the color 4.

If the color of the subject pixel is decided, then the pixel to be scanned is moved rightward by one pixel at step 1660. If the pixel is located at the rightmost end at step 1670, however, then the processing proceeds to step 1680. Otherwise, the processing proceeds to step 1630. In the same way, the pixel to be scanned is moved downward by one line at step 1680. If the pixel to be scanned is found to be in the lowest line at step 1690, then the processing is finished. Otherwise, the processing is returned to the step 1630 and the processing is continued.

In this example, one character is overwritten, and code information corresponding to one character is embedded in the background pattern. After all character information has been overwritten, however, its hash value may be repetitively in the background pattern.

In this example, creation of data for verification created in the first embodiment and statement of the data on the certificate are not conducted.

(2) Certificate Verifying

In the verifier system 230, the following verification is conducted. The verification of the digital signature can be conducted in the same way in the present embodiment as well. The verifier system 230 extracts the read certificate, transmits it to the board & certificate issuing system, and requests the board & certificate issuing system to verify the certificate. The board & certificate issuing system compares the pattern and character information of the regions 120 and 130 preserved for each board ID with the transmitted certificate, determines whether they coincide with each other, and transmits a result thereof to the verifier system.

3. Third Embodiment

(1) Certificate Issuing

In this embodiment, the board issuing system and the certificate issuing system are implemented as the same one system (referred to as board & certificate issuing system). Furthermore, the creation method of the background pattern in the region 120 and the region 130 differs from that of the first embodiment. Besides using a plurality of colors in the background pattern, the background pattern changes according to the individual information.

In this embodiment, characters are first written on the regions 120 and 130 of the certificate, and then the background is painted out with a plurality of colors.

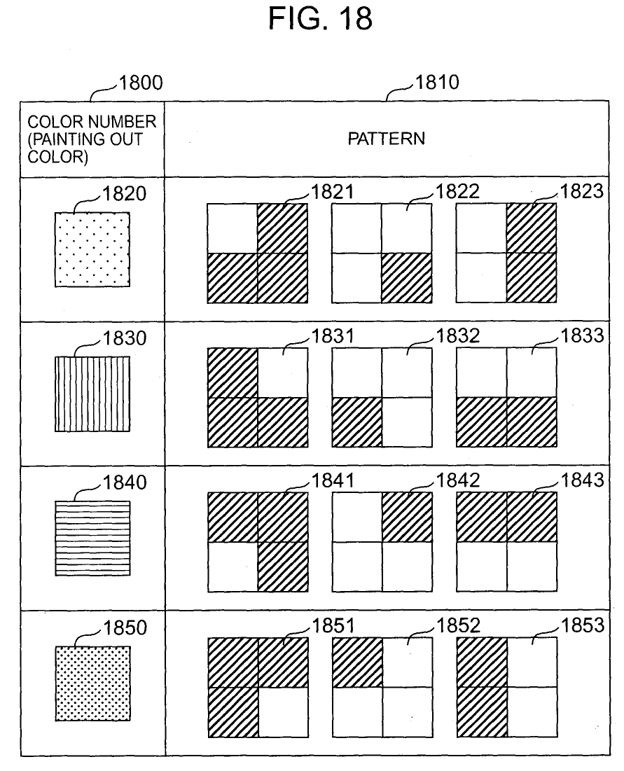

FIG. 18 is a diagram showing a rule for deciding a peripheral painting out color on the basis of the local shape of the first written character. First, each of the regions 120 and 130 with characters written thereon is divided into rectangles each having two by two pixels.

FIG. 18 is a table showing the relation between a pattern 1810 and a painting out color number 1800 of a pixel that is included in the pattern and not yet painted, based on 2 by 2 pixels including the character portion. If a rectangle composed of 2 by 2 pixels is taken as the unit, then there are 14 ways as patterns in which the rectangle is painted out with a character. Twelve ways obtained by excluding the case where all of the four pixels are painted out and the case where no pixels are painted out are classified into four cases. For example, let a color corresponding to a pattern 1821, a pattern 1822 and a pattern 1823 be 1820, a color corresponding to a pattern 1831, a pattern 1832 and a pattern 1833 be 1830, a color corresponding to a pattern 1841, a pattern 1842 and a pattern 1843 be 1840, and a color corresponding to a pattern 1851, a pattern 1852 and a pattern 1853 be 1850.

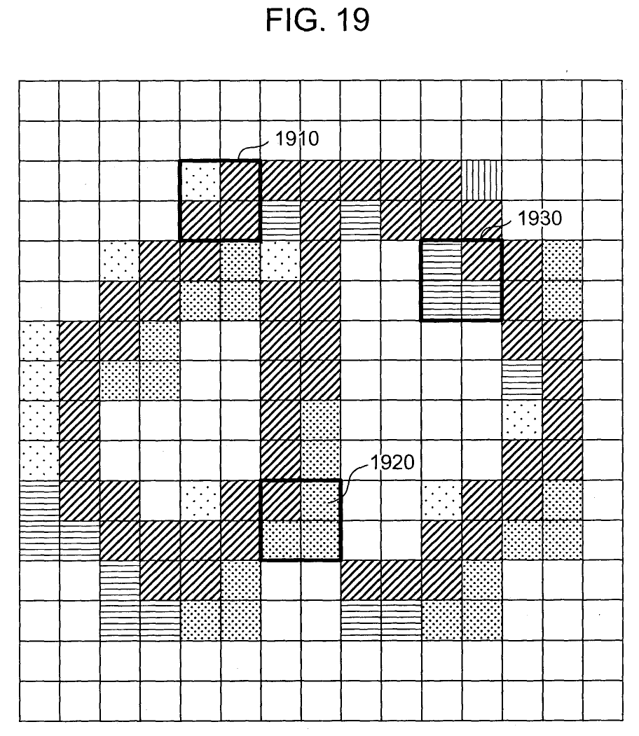

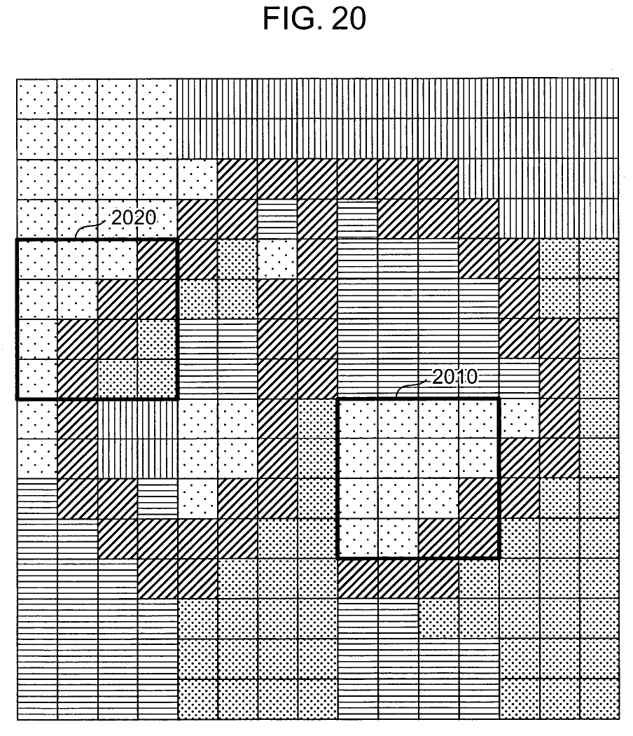

An example in which this rule is applied to a Japanese character “ [symbol] ” (pronounced as “no”) is shown in FIG. 19. Since at this time a rectangle 1910 in FIG. 19 is the same as the pattern 1821, its blank portion is painted out with the color 1820. Since a rectangle 1920 is the same as the pattern 1852, its blank portion is painted out with the color 1850. Since a rectangle 1930 is the same as the pattern 1842, its blank portion is painted out with the color 1840. By thus painting out the periphery of the character “ [symbol] ”, a result shown in FIG. 19 is obtained.

In FIG. 20, colors of portions that are not painted are decided. For this purpose, the region is divided into 4 pixel by 4 pixel rectangles, and the painting out color is decided according to the same rule as the rule described above. For example, since a rectangle 2010 becomes the same as the pattern 1822, the rectangle 2010 is painted out with the color 1820. Since a rectangle 2020 becomes the same as the pattern 1821, the rectangle 2020 is painted out with the color 1820.

If all regions are not painted out, then a region is divided into 8 pixel by 8 pixel rectangles and the rectangles are painted out in the same way. In addition, a region is divided into 16 pixel by 16 pixel rectangles and the rectangles are painted out. Such processing is repeated.

Subsequently, information such as the board ID is embedded in the region painted out by the above described method. It is now supposed that the encoded information shown in FIG. 4 for the first embodiment is embedded.

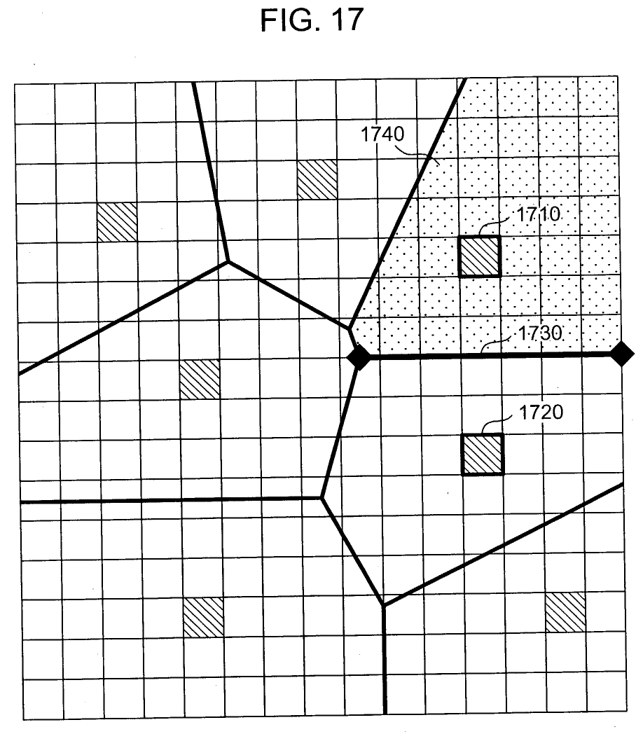

The dot pattern shown in FIG. 4 corresponds to a pixel 1710 and a pixel 1720 shown in FIG. 17. By using pixels such as 1710 and 1720, a Voronoi diagram is created. The Voronoi diagram is a well-known region division method, and it is created as heretofore described. Two adjacent points in a region are connected with a line, and at a point bisecting the line, a straight line perpendicular to the line is drawn. By repeating this operation with respect to all points, the region is divided as shown in FIG. 17. By creating the Voronoi diagram, a closed region including each of dots included in the pattern can be defined.

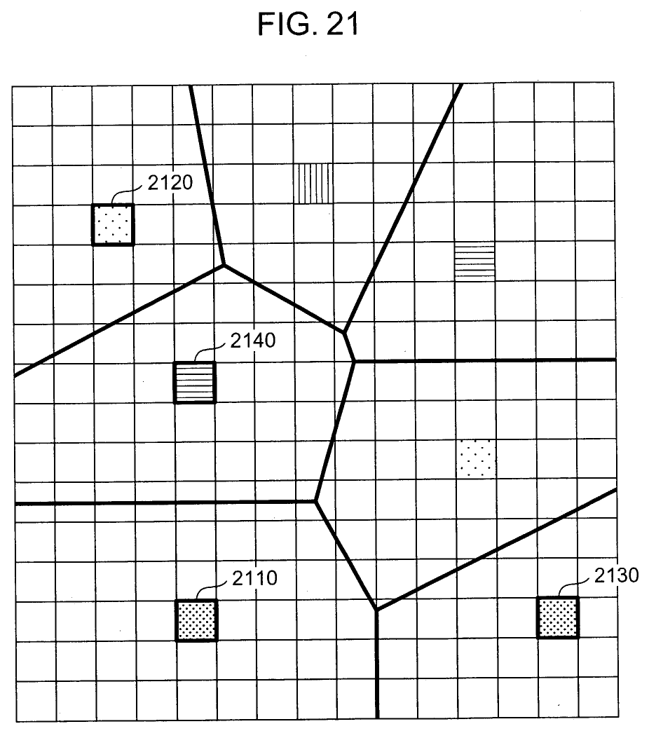

By superposing FIG. 17 on FIG. 20, FIG. 21 is obtained.

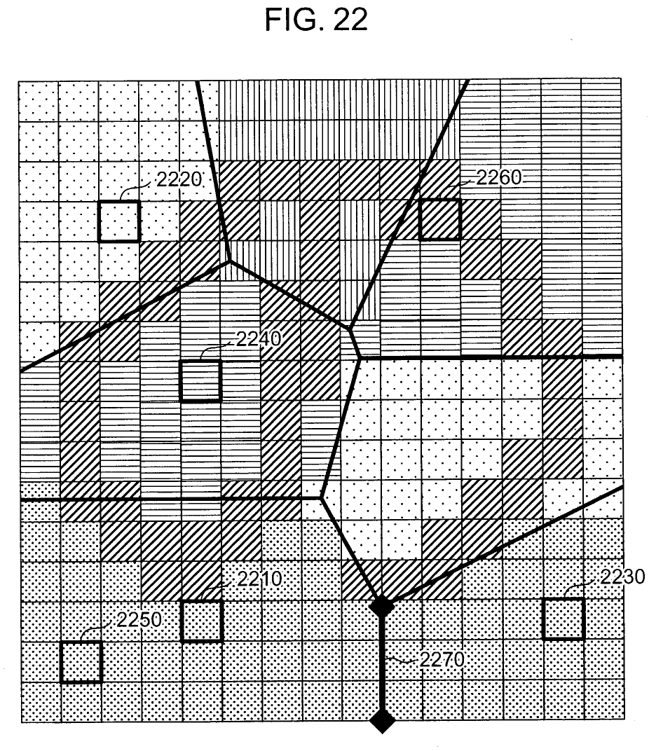

In addition, inside of a closed region in FIG. 21 is painted out with the color of the point in the closed region. If the point is overwritten by the character such as pixel 2260, the closed region is painted out by the color of the none-overwritten pixel most close to the point. In FIG. 22, regions other than the character are thus painted out. In this way, the periphery of the character is painted out separately with four colors.

In this way, the board & certificate issuing system creates the regions 120 and 130 of the certificate.

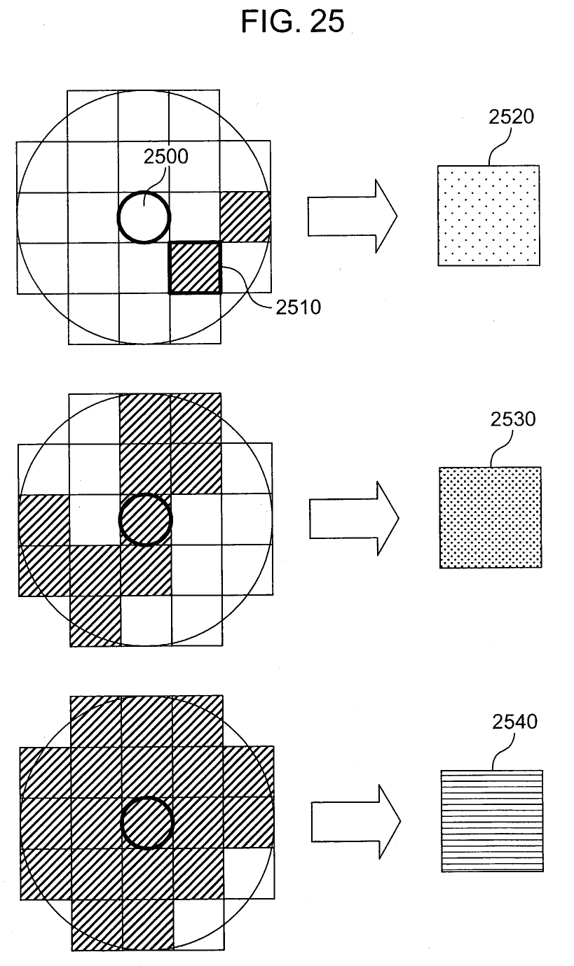

An alternative rule different from the painting out rule shown in FIG. 18 is shown in FIG. 25. In FIG. 25, the color is decided according to the degree to which the periphery of the subject pixel is painted out with a character. If the degree is less than 30% in the periphery 2510 of the pixel 2500, then a color 2520 is used as the painting out color. If the degree is between 30% and 60%, then a color 2530 is used as the painting out color. If the degree is at least 60%, then a color 2540 is used as the painting out color. Thereafter, the regions 120 and 130 of the certificate are created by using the method described with reference to FIGS. 21 and 22.

(2) Certificate Verifying

In the verifier system 230, the following verification is conducted. The verification of the digital signature can be conducted in the same way in the present embodiment as well. The verifier system 230 extracts characters in the regions 120 and 130 of the read certificate, and paints out the background by using the method described with reference to FIGS. 18, 19 and 20 (or FIG. 25). Subsequently, the verifier system 230 transmits the board ID to the board & certificate issuing system, and obtains the dot pattern from the board & certificate issuing system. The verifier system 230 re-paints the background according to the method described with reference to FIGS. 21 and 22 by using the obtained dot pattern, and outputs a result to the printer. By visually comparing the color pattern in the regions 120 and 130 of the certificate with the color pattern output from the printer, forgery of the certificate can be detected. The verifier system may compares the color patterns with each other and output only the coincidence or noncoincidence.

As a variant of the present embodiment, it is possible to encode the coordinate information of the dot pattern shown in FIG. 4 and state it in the region 330 of the certificate, when creating the certificate. In this case, the verifier system can perform the above-described verification on the basis of the information on the certificate without connecting to the board & certificate issuing system, when verifying the certificate.

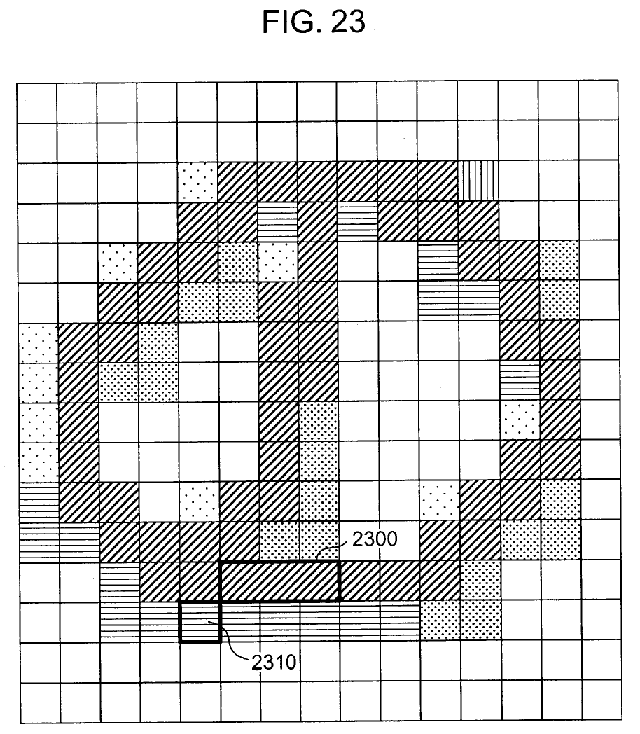

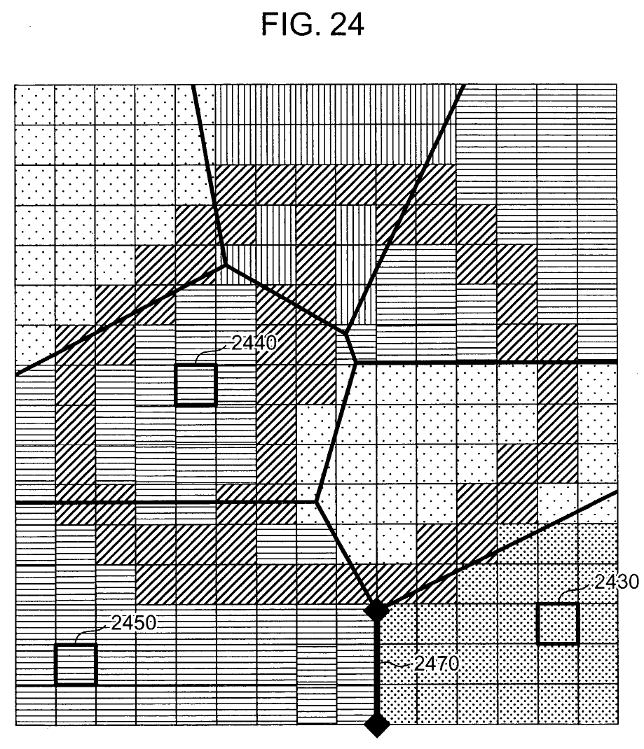

An example of forgery will now be described. In FIG. 23, a part of the character “ [symbol] ” is falsified. For example, a region 2300 is painted out, and the character is falsified. If the rule shown in FIG. 18 is applied with respect to this character, then a dot 2310 is painted out with the color 1840. And regions represented by the Voronoi diagram are painted as shown in FIG. 24. In FIG. 22, a dot 2230 and a dot 2250 have the same color, and both sides of a boundary line 2270 are painted out with the same color 1850. On the other hand, in FIG. 24, a dot 2430 is different in color from a dot 2450. Therefore, the left-hand side of the boundary line has the color 1840, whereas the right-hand side of the boundary has the color 1850. Therefore, the difference between FIG. 22 and FIG. 24 can be discriminated visually. Such a color change can occur not only when a part of a character shape is falsified, but also when the position of the character is shifted slightly.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A method for issuing a certificate by using a computer, comprising the steps of:
inputting individual information of a certificate issuance requester;
creating electronic data of a board, the board having a background pattern that differs from certificate to certificate in a part thereof;
overwriting individual information on the background pattern in the electronic data of the board by using characters, and entering a relation between the background pattern and the overwritten characters onto the board; and
printing the electronic data as a certificate.

2. The certificate issuing method according to claim 1, wherein the background pattern of the certificate board is a pattern obtained by encoding information that differs from certificate to certificate and representing a resultant code by using dots.

3. The certificate issuing method according to claim 2, wherein the relation between the background pattern and the overwritten characters comprises a total number of dots in the background pattern before character overwriting, and a number of dots overwritten with characters.

4. The certificate issuing method according to claim 3, wherein the relation between the background pattern and the overwritten characters further comprises coordinate information of dots overwritten with characters.

5. The certificate issuing method according to claim 2, wherein the relation between the background pattern and the overwritten characters is encoded and entered onto the board.

6. The certificate issuing method according to claim 1, further comprising the steps of:
entering information at time of board creation and a digital signature for guaranteeing the information at the time of board creation onto the board; and
entering a digital signature for guaranteeing the individual information onto the board.

7. A certificate, wherein
a background pattern unique to the certificate is printed on a part of a board,
individual information is overwritten on the background pattern by using characters, and
a relation between the background pattern and overwritten characters is entered onto the board.

8. A method for verifying a certificate issued by using the method of claim 1, comprising the steps of:
converting the certificate to electronic data;
extracting a region in which individual information is overwritten on a background pattern with characters, from the certificate;
reading out a relation between the background pattern and overwritten characters entered onto the certificate;
effecting a check to determine whether the background pattern and the characters in the region satisfy the relation read out; and
judging the certificate to be invalid when the background pattern and the characters in the region do not satisfy the relation read out.

9. A certificate issuing system comprising:
a requester terminal for inputting individual information of a certificate issuance requester;
a board issuing device for creating electronic data of a board, the board having a background pattern that differs from certificate to certificate in a part thereof;
a certificate issuing device for receiving the electronic data of the board from said board issuing device, overwriting individual information received from said requester terminal on the background pattern by using characters, and entering a relation between the background pattern and overwritten characters onto the board,
wherein said requester terminal prints electronic data received from said certificate issuing device, as the certificate.

10. A device for verifying a certificate issued by the system of claim 9, comprising:
an input device for converting the certificate to electronic data;
a relation readout unit for reading out a relation between a background pattern of the certificate and overwritten characters from the certificate;
a region extraction unit for extracting a region in which individual information is overwritten on the background pattern with characters, from the certificate;
a check unit for effecting a check to determine whether the background pattern and the characters in the region satisfy the relation read out; and
a judgment unit for judging the certificate to be invalid when the background pattern and the characters in the region do not satisfy the relation read out.
